(19) United States
(12) Patent Application Publication
(10) Pub. No.: US 2013/0079470 A1
(43) Pub. Date: Mar. 28, 2013

(54) RESIN COMPOSITION, METHOD FOR PRODUCING THE SAME, AND MOLDED ARTICLE USING THE SAME

(71) Applicant: Sumitomo Chemical Company, Limited, Tokyo (JP)

(72) Inventors: Saho NOJIRI, Ichihara-shi (JP); Shuichi KIMATA, Ichihara-shi (JP)

(73) Assignee: SUMITOMO CHEMICAL COMPANY, LIMITED, Tokyo (JP)

(21) Appl. No.: 13/623,257

(22) Filed: Sep. 20, 2012

(30) Foreign Application Priority Data
Sep. 22, 2011 (JP) 2011-207115

(51) Int. Cl. C08L 23/12

(52) U.S. Cl. 525/240

(57) ABSTRACT

Disclosed is a resin composition that is superior in balance between toughness and flowability and contains little VOC components, specifically a composition comprising 20-80 wt % polymer (A1), 5-55 wt % polymer (A2), and 10-50 wt % copolymer (B), wherein the MFR of the composition is 20 g/10 min or more, the polymer (A1) being a propylene polymer having an intrinsic viscosity of from 0.5 dl/g (inclusive) to 2.0 dl/g (exclusive), a molecular weight distribution of less than 3.0, and a content of propylene-derived structural units of 90 wt % or more, the polymer (A2) being a propylene polymer having an intrinsic viscosity of from 2.0 to 7.0 dl/g, a molecular weight distribution of 3.0 or more, and a content of propylene-derived structural units of 90 wt % or more, the copolymer (B) being a copolymer of ethylene with propylene or a C4-20 α-olefin having a content of ethylene-derived structural units of 20 to 80 wt %.

### BACKGROUND OF THE INVENTION

1. Field of the Invention

The present invention relates to a resin composition that is superior in balance between toughness and flowability, a method for producing the composition, and a molded article using the composition.

2. Related Art

Polypropylene resins are materials superior in rigidity, impact resistance, and the like, and they are used for a wide variety of applications in the form of molded articles such as automotive interior or exterior components and housings of electric appliances. Among polypropylene resins, those to be used for such applications include so-called “impact copolymers” in which a polyethylene component or a non-crystalline or low-crystalline propylene-ethylene copolymer has been dispersed in a crystalline polypropylene by copolymerization with ethylene. Such impact copolymers are well balanced between rigidity and impact resistance and are used for molding materials for industrial components including automotive interior or exterior components such as bumpers, instrument panels, and garnishes and household electric appliance components such as television housings. However, since such products have recently been reduced in thickness, increased in functionality, and increased in size, materials are required to be enhanced in performance. In particular, for increasing the size of products, it has been desired to improve materials in molding performance through increase in flowability.

JP 62-195032 A discloses a polypropylene polymer composition composed of 50 to 94% by weight of a propylene polymer having an intrinsic viscosity of not less than 0.5 dl/g but less than 2.5 dl/g polymerized using a stereoregular catalyst, 3 to 30% by weight of a propylene polymer having an intrinsic viscosity of 2.5 dl/g or more, and 3 to 30% by weight of a propylene-ethylene copolymer having an intrinsic viscosity of 2.8 dl/g or more is superior in whitening resistance, impact resistance and rigidity.

JP 7-149974 A discloses that a blend of different polymers characterized by containing a) a propylene homopolymer having an MFR of 0.001 to 5 g/10 min, b) a propylene/ethylene copolymer having an ethylene content of 5 to 80 w/w %, and c) a propylene homopolymer having an MFR of 1 to 10⁴ g/10 min, wherein the ratio of the MFR of the propylene homopolymer c) to the MFR of the propylene homopolymer a) is within the range of from 10:1 to 10⁷:1 exhibits good flowability but has good mechanical characteristics, especially high rigidity.

WO 94/16009 A discloses that a propylene polymer composition is superior in heat resistance, mechanical strength, tensile elongation at break, etc., the composition being composed of 10 to 90% of (A3) a propylene polymer that is prepared by polymerizing propylene in the presence of a catalyst component for olefin polymerization containing a solid titanium-containing catalyst component and an organometallic compound catalyst component and has an MFR being within the range of 0.01 to 30 g/10 min and a molecular weight distribution (Mw/Mn) determined by GPC being within the range of 4 to 15; and 90 to 10% of (A4) a propylene polymer that is prepared by polymerizing propylene in the presence of a catalyst component for olefin polymerization containing a compound of a transition metal of Group IVB of the Periodic Table containing a ligand having a cyclopentadienyl skeleton and at least one compound selected from the group consisting of organoaluminumoxy compounds and compounds capable of reacting with the transition metal compound to form an ion pair and has an MFR being within the range of 30 to 1000 g/10 min and a molecular weight distribution (Mw/Mn) determined by GPC being within the range of 2 to 4.

However, the polypropylene polymer compositions disclosed in the above-cited patent documents are not high enough in their performance and have been demanded to be further improved in flowability while maintaining the balance of mechanical properties. The object of the present invention is to provide a resin composition being well balanced in toughness and flowability, a method for producing the same, and a molded article using the same.

### SUMMARY OF THE INVENTION

The present invention relates to a resin composition comprising 20 to 80% by weight of polymer (A1) defined below, 5 to 55% by weight of polymer (A2) defined below, and 10 to 50% by weight of copolymer (B) defined below, where the total weight of the polymer (A1), the polymer (A2), and the copolymer (B) is considered to be 100% by weight, wherein the melt flow rate (MFR) of the resin composition measured at 230° C. under a load of 2.16 kg is 20 g/10 min or more,

polymer (A1): a propylene polymer having an intrinsic viscosity measured in 135° C. Tetralin ([η]^{A1}_{P}) of not lower than 0.5 dl/g but lower than 2.0 dl/g, a molecular weight distribution (Mw/Mn) of less than 3.0, and a content of structural units derived from propylene of 90% by weight or more,

polymer (A2): a propylene polymer having an intrinsic viscosity measured in 135° C. Tetralin ([η]^{A2}_{P}) of not lower than 2.0 dl/g and not higher than 7.0 dl/g, a molecular weight distribution (Mw/Mn) of not less than 3.0, and a content of structural units derived from propylene of 90% by weight or more,

copolymer (B): a copolymer of ethylene with propylene or an α-olefin having 4 to 20 carbon atoms, the copolymer having a content of structural units derived from ethylene of 20 to 80% by weight.

According to the present invention, a resin composition can be obtained which is well balanced in toughness and flowability.

### DESCRIPTION OF THE PREFERRED EMBODIMENTS

The resin composition of the present invention comprises 20 to 80% by weight of polymer (A1) defined below, 5 to 55% by weight of polymer (A2) defined below, and 10 to 50% by weight of copolymer (B) defined below, where the total weight of the polymer (A1), the polymer (A2), and the copolymer (B) is considered to be 100% by weight, wherein the melt flow rate (MFR) of the resin composition measured at 230° C. under a load of 2.16 kg is 20 g/10 min or more,

polymer (A1): a propylene polymer having an intrinsic viscosity measured in 135° C. Tetralin ([η]^{A1}_{P}) of not lower than 0.5 dl/g but lower than 2.0 dl/g, a molecular weight distribution (Mw/Mn) of less than 3.0, and a content of structural units derived from propylene of 90% by weight or more,

polymer (A2): a propylene polymer having an intrinsic viscosity measured in 135° C. Tetralin ([η]^{A2}_{P}) of not lower than 2.0 dl/g and not higher than 7.0 dl/g, a molecular weight distribution (Mw/Mn) of not less than 3.0, and a content of structural units derived from propylene of 90% by weight or more,

copolymer (B): a copolymer of ethylene with propylene or an α-olefin having 4 to 20 carbon atoms, the copolymer having a content of structural units derived from ethylene of 20 to 80% by weight.

The content of the polymer (A1) contained in the resin composition is 20 to 80% by weight, preferably 23 to 80% by weight, and more preferably 25 to 80% by weight.

When the content of the polymer (A1) is less than 20% by weight, the MFR of the resin composition may lower and flowability may decrease. When the content exceeds 80% by weight, toughness may deteriorate.

The content of the polymer (A2) contained in the resin composition is 5 to 55% by weight, preferably 5 to 52% by weight, and more preferably 5 to 50% by weight. When the content of the polymer (A2) is less than 5% by weight, impact resistance may deteriorate. When the content exceeds 55% by weight, the MFR of the polypropylene resin composition may lower and flowability may decrease.

The intrinsic viscosity of the polymer (A1) measured in 135° C. tetralin ([η]^{A1}_{P}) is not less than 0.5 dl/g but less than 2 dl/g, preferably not less than 0.6 dl/g but less than 1.8 dl/g, and more preferably not less than 0.7 dl/g but less than 1.5 dl/g. When [η]^{A1}₉ₚ is less than 0.5 dl/g, deterioration in toughness is invited and when [η]^{A1}_{P} exceeds 2.0 dl/g, flowability is low and deterioration in processability is invited.

The intrinsic viscosity of the polymer (A2) measured in 135° C. tetralin ([η]^{A2}_{P}) is from 2.0 dl/g to 7.0 dl/g, preferably from 2.3 dl/g to 6.0 dl/g, and more preferably from 2.5 dl/g to 5.0 dl/g. When [η]^{A2}_{P} is less than 2.0 dl/g, toughness is not high enough, so that the tensile elongation at break of a molded article may decrease and when [η]^{A2}_{P} exceeds 7.0 dl/g, flowability is low and deterioration in processability is invited.

The ratio of the weight average molecular weight (Mw) to the number average molecular weight (Mn) of the polymer (A1) measured by gel permeation chromatography (GPC) (namely, molecular weight distribution (Mw/Mn)) is less than 3.0, preferably less than 2.8, and more preferably less than 2.5. When the Mw/Mn of the polymer (A1) is 3.0 or more, toughness is not high enough, so that the tensile elongation at break of a molded article may decrease.

The Mw/Mn of the polymer (A2) measured by GPC is 3.0 or more, preferably 3.2 or more, and more preferably 3.5 or more. When the Mw/Mn of the polymer (A2) is less than 3.0, the tensile elongation at break of a molded article may decrease.

The content of structural units derived from propylene contained in the polymer (A1), i.e., the propylene content measured by ¹³C-NMR spectroscopy is 90% by weight or more, and preferably 95% by weight or more (where the overall weight of the polymer (A1) is considered to be 100% by weight). If the propylene content is less than 90% by weight, the polymer (A1) is excessively compatible with the copolymer (B), so that rigidity may be insufficient.

The content of structural units derived from propylene contained in the polymer (A2), i.e., the propylene content measured by ¹³C-NMR spectroscopy is 90% by weight or more, and preferably 95% by weight or more (where the overall weight of the polymer (A2) is considered to be 100% by weight). If the propylene content is less than 90% by weight, the polymer (A2) is excessively compatible with the copolymer (B), so that rigidity may be insufficient.

The polymer (A1) and the polymer (A2) each may contain structural units derived from ethylene and structural units derived from an α-olefin having 4 to 20 carbon atoms in addition to structural units derived from propylene. Examples of the α-olefin having 4 to 20 carbon atoms include 1-butene, 1-hexene, and 1-octene. Preferred as the polymer (A1) is a propylene homopolymer component, and preferred as the polymer (A2) is a propylene homopolymer component.

When polymerized, propylene generally forms a head-to-tail bonded sequence like that represented by the following formula (I) with 1,2-insertion (in which the methylene groups bond a catalyst), but 2,1-insertion or 1,3-insertion also unusually occurs. The propylene units having 2,1-insertion or 1,3-insertion form irregularly arranged units as represented by the formulae (II) and (III).

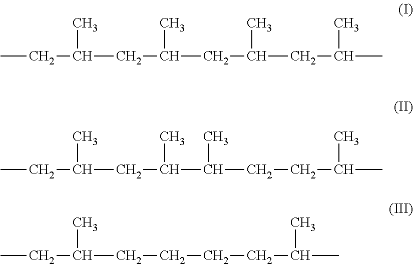

As for the polymer (A1), the proportion of regio defects caused by 2,1-insertion and 1,3-insertion in all propylene units measured by ¹³C nuclear magnetic resonance (¹³C-NMR) spectroscopy is preferably 0.01 or less.

The above “proportion of regio defects caused by 2,1-insertion and 1,3-insertion in all propylene units” of the propylene polymer is the sum total of the proportion of regio defects caused by a 2,1-insertion reaction and the proportion of regio defects caused by a 1,3-insertion reaction in polypropylene molecular chains measured by ¹³C-NMR according to the method disclosed in Tsutsui, et al., POLYMER, 30, 1350 (1989).

In the polymer (A1) to be used in the present invention, the proportion of regio defects caused by 2,1-insertion and 1,3-insertion in all propylene units is preferably 0.01 or less, more preferably 0.008 or less, and even more preferably 0.005 or less. When the proportion of regio defects exceeds 0.01, molded articles may be insufficient in rigidity.

The polymer (A1) and the polymer (A2) each may be composed of two or more different propylene polymer components as long as the polymer structure described above is fulfilled.

Examples of the methods for producing the polymer (A1) and the polymer (A2) include a method in which raw materials, i.e., propylene, ethylene, and an α-olefin having 4 to 20 carbon atoms, are polymerized by a conventional method using a conventional stereoregular catalyst.

Examples of the stereoregular catalyst include a catalyst that is formed by bringing a solid titanium-containing catalyst component, an organometallic compound catalyst component, and an electron donor that is further used according to need into contact with each other, a catalyst system that is formed by bringing a compound of a transition metal of Group 4 of the periodic table which compound has a cyclopentadienyl ring, and an alkyl aluminoxane into contact with each other, and a catalyst that is formed by bringing a compound of a transition metal of Group 4 of the periodic table which compound has a cyclopentadienyl ring, and a compound capable of reacting with the compound of the transition metal to form an ionic complex, and an organoaluminum compound into contact with each other. Particularly preferred is the catalyst that is formed by bringing a solid titanium-containing catalyst component, an organometallic compound catalyst component, and an electron donor that is further used according to need into contact with each other.

Generally, it is known that narrow molecular weight distribution can be made narrower by mixing an organic peroxide with a polypropylene resin in a molten phase. As to the polymer (A1), a polymer whose molecular weight (Mw) and molecular weight distribution (Mw/Mn) have been adjusted by using an organic peroxide may be used.

Examples of the above-mentioned organic peroxide include conventional organic peroxides, and preferred is an organic peroxide whose decomposition temperature at which the half life thereof becomes one minute is 120° C. or higher.

Examples of the organic peroxide whose decomposition temperature at which the half life thereof becomes one minute is 120° C. or higher include 1,1-bis(tert-butylperoxy)cyclohexane, 2,2-bis(4,4-di-tert-butylperoxycyclohexyl)propane, 1,1-bis(tert-butylperoxy)cyclododecane, tert-hexylperoxyisopropyl monocarbonate, tert-butylperoxy-3,5,5-trimethyl hexanoate, tert-butyl peroxylaurate, 2,5-dimethyl-2,5-di-(benzoylperoxy)hexane, tert-butyl peroxyacetate, 2,2-bis(tert-butylperoxy)butene, tert-butyl peroxybenzoate, n-butyl-4,4-bis(tert-butylperoxy)valerate, di-tert-butyl peroxyisophthalate, dicumyl peroxide, α,α′-bis(tert-butylperoxy-m-isopropyl)benzene, 2,5-dimethyl-2,5-di(tert-butylperoxy)hexane, 1,3-bis(tert-butylperoxyisopropyl)benzene, tert-butyl cumyl peroxide, di-tert-butyl peroxide, p-menthane hydroperoxide and 2,5-dimethyl-2,5-di-(tert-butylperoxy)hexyne-3. An organic peroxide which has a decomposition temperature of 150° C. or higher at which the half life of the organic peroxide is one minute is more preferable.

The copolymer (B) is a copolymer produced by copolymerizing ethylene with propylene or an α-olefin having 4 to 20 carbon atoms. Examples of the α-olefin having 4 to 20 carbon atoms include 1-butene, 1-hexene, and 1-octene; either one α-olefin or two or more α-olefins may be used.

The copolymer (B) can be produced by conventional polymerization method using a catalyst formed by bringing a solid titanium-containing catalyst component, an organometallic compound catalyst component, and an electron donor, which is optionally used, into contact with each other, a catalyst system formed by bringing a compound of a transition metal of Group 4 of the periodic table having a cyclopentadienyl ring, and an alkyl aluminoxane into contact with each other, or a catalyst formed by bringing a compound of a transition metal of Group 4 of the periodic table having a cyclopentadienyl ring, and a compound capable of reacting with the compound of the transition metal to form an ionic complex, and an organoaluminum compound into contact with each other.

The content of the copolymer (B) contained in the resin composition is 10 to 50% by weight, preferably 10 to 45% by weight, and more preferably 10 to 40% by weight. When the content of the copolymer (B) is less than 10% by weight, impact resistance may deteriorate. If the content exceeds 50% by weight, deterioration in rigid is invited, so that sufficient mechanical property balance cannot be attained.

The content of structural units derived from ethylene contained in the copolymer (B), i.e., the ethylene content measured by ¹³C-NMR spectroscopy is 20 to 80% by weight, preferably 30 to 70% by weight (where the overall weight of the copolymer (B) is considered to be 100% by weight). If the ethylene content is less than 20% by weight, the copolymer (B) is excessively compatible with the polymer (A1) and the polymer (A2), so that rigidity may be insufficient. On the other hand, when the ethylene content is more than 80% by weight, impact resistance may be insufficient because the copolymer (B) is not sufficiently high in compatibility with the polymer (A1) and the polymer (A2) and a polyethylene crystal component generates.

The intrinsic viscosity of the copolymer (B) measured in 135° C. tetralin ([η]) is preferably higher than 1.0 dl/g, more preferably higher than 1.5 dl/g, and even more preferably higher than 2.0 dl/g.

The melt flow rate (MFR) of the resin composition of the present invention measured at 230° C. under a load of 2.16 kg is 20 g/10 min or more, preferably 23 g/10 min or more, and more preferably 25 g/10 min or more. When the MFR of the polypropylene resin composition is less than 20 g/10 min, flowability may be low and processability may deteriorate.

Among the components contained in the resin composition, the content of the components having a polystyrene-equivalent weight average molecular weight (Mw) determined by GPC of up to 21000 is preferably less than 5.0% by weight, and more preferably less than 4.8% by weight. When the content of the components having a Mw of up to 21000 is less than 5.0% by weight, it is possible to avoid deterioration in toughness and to reduce the amount of VOC components to be released from the resin composition.

To the resin composition of the present invention, additives and inorganic filler may be added according to need as long as the object of the present invention is not impaired.

Examples of the additives include antioxidants, UV absorbers, antistatic agents, lubricants, nucleating agents, pressure-sensitive adhesives, anticlouding agents, and antiblocking agents.

Examples of the above-mentioned inorganic filler include calcium carbonate, barium sulfate, mica, crystalline calcium silicate, talc, and magnesium sulfate fiber. Such inorganic fillers may be used in combination.

Examples of the method for producing the resin composition of the present invention include

(1) a method in which the composition is produced by producing the polymer (A1) and the polymer (A2), and consecutively the copolymer (B) by polymerization,
(2) a method in which the composition is produced by melt-kneading the polymer (A1) and the polymer (A2) and the copolymer (B) at once,
(3) a method in which the composition is produced by feeding the polymer (A1) and the polymer (A2) and the copolymer (B) to a mixing apparatus sequentially and then melt-kneading them, and
(4) a method in which the composition is produced by producing a polypropylene resin component (C) composed of the polymer (A2) and the copolymer (B) by a multi-stage polymerization and then mixing the polypropylene resin component (C) and the polymer (A1); among these preferred is method (4), which is superior in the dispersibility of the copolymer (B) in a resin composition.

The above-mentioned melt-kneading can be performed by using a conventional method and a conventional apparatus. Examples of the method include a method in which the polymer (A1), the polymer (A2), the copolymer (B) and various additives are mixed with a mixing apparatus such as a Henschel mixer, a ribbon blender, and a tumble mixer, and then are melt-knead; and a method in which the polymer (A1), the polymer (A2), the copolymer (B) and various additives are fed, respectively, at a certain rate continuously by means of a metering feeder to obtain a uniform mixture, and then the mixture is melt-kneaded by using an extruder equipped with a single screw or two or more screws, a Banbury mixer, a roll type kneading machine, or the like.

The melt-kneading temperature is preferably 180° C. to 350° C., more preferably 180° C. to 320° C., and even more preferably 180° C. to 300° C.

Molded articles can be obtained by molding the resin composition of the present invention by a method usually used industrially. Examples of such a molding method include extrusion forming, blow molding, injection molding, compression molding, and calendering.

Examples of the applications of the resin composition of the present invention include automobile materials, home electric materials, and furniture.

### EXAMPLES

The present invention is illustrated by the following Examples and Comparative Examples. The measurements of the respective items disclosed in the detailed description of the invention, Examples and Comparative Examples were measured by the following methods.

(1) Intrinsic Viscosity ([η], unit: dl/g)

Reduced viscosities were measured at three concentrations of 0.1, 0.2 and 0.5 g/dl using a Ubbelohde's viscometer. The intrinsic viscosity was calculated by the calculation method described in “Kobunshi Yoeki (Polymer Solution), Kobunshi Jikkengaku (Polymer Experiment Study) Vol. 11” page 491 (published by Kyoritsu Shuppan Co., Ltd., 1982), specifically, by an extrapolation method in which reduced viscosities are plotted against concentrations and the concentration is extrapolated in zero. The reduced viscosities were measured at a temperature of 135° C. using Tetralin as solvent.

(2) Melt Flow Rate (MFR, Unit: g/10 min)

Measurement was carried out in accordance with the method provided in JIS K7210. The measurement was carried out at a temperature of 230° C. under a load of 2.16 kg unless otherwise stated.

(3) Weight Average Molecular Weight (Mw) and Molecular Weight Distribution (Mw/Mn)

A weight-average molecular weight (Mw) and a number-average molecular weight (Mn) were measured by GPC under the following conditions, and then their ratio (Mw/Mn) was calculated.

Instrument: Model 150C manufactured by Waters Corporation

Column: TSK-GELGMH6-HT, 7.5 φmm×300 mm×3 columns

Measurement temperature: 140° C.

Solvent: o-dichlorobenzene

Measurement concentration: 5 mg/5 ml

### (4) Proportion of Regio Defects (Unit: mol %)

A “proportion of regio defects caused by 2,1-insertion and 1,3-insertion in all propylene units” in a polymer was determined from a ¹³C-NMR spectrum measured under the following conditions, according to a report of Tsutsui, et al. (POLYMER, 30, 1350 (1989)). A sample was prepared by dissolving about 250 mg of a propylene polymer in 2.5 ml of orthodichlorobenzene homogeneously in a 10 mmφ test tube, and a ¹³C-NMR spectrum of the sample was measured under the following conditions.

Instrument: Bruker AVANCE600 with a 10 mm cryoprobe

Measurement temperature: 130° C.

Pulse repetition time: 4 seconds

Pulse width: 45°

Cumulated number: 700

(5) Intrinsic Viscosity ([η]A) of Polymer (A1) or Polymer (A2) and Intrinsic Viscosity (Mb) of Copolymer (B) in Polypropylene Resin Component (C) Obtained by Producing Polymer (A1) or Polymer (A2) in First Step by Polymerization and Producing Copolymer (B) in Second Step by Polymerization

The intrinsic viscosity ([η]A) of the polymer (A1) or the polymer (A2) produced by the earlier polymerization (first step) was determined by method (1) described above by measuring the intrinsic viscosity of a polymerized sample taken out of a polymerization vessel after the completion of the first step. The intrinsic viscosity ([η]B) of the copolymer (B) produced in the later stage (second step) was determined by the following method.

The intrinsic viscosity ([η]C) of the polymerized powder of the polypropylene resin component (C) obtained after the completion of the later stage was measured by method (1) described above, and then the intrinsic viscosity of the copolymer (B) was determined from the following equation using the weight ratio (Y) of the copolymer (B) to the polypropylene resin component (C) (the weight ratio (Y) of the copolymer (B) was determined by the method described in the following (6)).

[η]B={[η]C−(1−Y)×[η]A2}/Y

[η]A: intrinsic viscosity of polymer (A1) or polymer (A2) produced in the earlier stage (first step)

[η]C: intrinsic viscosity of polypropylene resin component (C) obtained after the completion of the later stage (second step)

Y: weight ratio of copolymer (B) to polypropylene resin component (C) obtained after the completion of the later stage

### (6) Weight Ratio (Y) of Copolymer (B) to Polypropylene Resin Component (C), and Ethylene Content (% by Weight) in Copolymer (B)

The weight ratio (Y) of the copolymer (B) to the polypropylene resin component (C) obtained after the completion of the later stage, and the ethylene content (% by weight) in the copolymer (B) were determined from a ¹³C-NMR spectrum measured under the following conditions, according to a report of Kakugo et al. (Macromolecules 1982, 15, 1150-1152). A sample was prepared by dissolving about 200 mg of a polymer sample in 3 mL of orthodichlorobenzene homogeneously in a 10 mmφ test tube, and a ¹³C-NMR spectrum of the sample was measured under the following conditions.

Instrument: Bruker AVANCE600 with a 10 mm cryoprobe

Measurement temperature: 135° C.

Pulse repetition time: 4.3 seconds

Pulse width: 45°

Cumulated number: 2,500

### (3) Tensile Elongation at Break (UE, Unit: %)

Using a molded article adjusted to 2 mm in thickness, tensile elongation at break was measured in accordance with ASTM D638 under the following conditions.

Measurement temperature: 23° C.

Tensile speed: 50 mm/min

### (8) Shear Viscosity

Shear viscosity was measured by using a Capillograph 1B manufactured by Toyo Seiki Seisaku-Sho Co., Ltd. under the following conditions.

Measurement temperature: 220° C.

L/D: 40

Shear rate: 2.432×10³ sec⁻¹

(9) Measurement of the Amount of Volatile Substances (Unit: ppm)

The amount of volatile substances contained in a sample was measured by using an HS-GC/FID analyzer under the following conditions. All components detected during a period of 20 minutes from the injection of a sample gas into the GC were assumed to be n-heptane and the combined amount of the substances was measured.

### HS (Headspace) Conditions

Measuring instrument: HEADSPACE Autosampler 7000 (manufactured by Tekmar)

Heating temperature/time: 120° C./60 minutes

Sample weight: 0.5 g

### GC Conditions

Measuring instrument: GC-14A (manufactured by Shimadzu Corporation)

Column: DB-WAX 0.53 mm×60 m×1.0

Oven: A sample gas was injected at 50° C., heated up to 100° C. at a rate of 5° C./rain, further heated up to 230° C. at a rate of 20° C./min, and then held for 5 minutes.

Detector: hydrogen flame ionization detector (230° C.)

(10) Measurement of the Amount of Oligomers (Unit: ppm)

A polypropylene resin composition was processed into a 100-μm thick pressed sheet, and 1 g of the sheet was subjected to ultrasonic extraction in 10 ml of tetrahydrofuran for 1 hour, followed by measurement the amount of oligomer components using a GC/FID analyzer under the following conditions. All components detected were assumed to be n-pentadecane and the combined amount of the components was measured.

Measuring instrument: GC-2010 (manufactured by Shimadzu Corporation)

Column: apolar 0.53 mm×15 m×1.5

Oven: A sample was injected at 100° C., then held for 1 minute, then heated up to 310° C. at a rate of 10° C./min, and then held for 20 minutes.

Carrier gas: helium 10 ml/min

The amount of sample liquid injected: 2 μl

Injection temperature: 310° C.

### (11) The Amount of Film Extracted in N-Hexane (Unit: % by Weight)

In accordance with the method of FDA 177.1520 (d) (3) (ii), the amount of a 100-μm thick film extracted in n-hexane of 50° C. was measured.

### (12) Fogging (Unit: %)

A fogging property test was carried out under the following conditions; the gloss and the haze of a glass surface were measured and their values before and after an experiment was compared.

Measuring instrument: Window screen fogging tester, Model WF-2, manufactured by Suga Test Instruments Co., Ltd.

Heating condition: 120° C.

Cooling condition: 25° C.

Time: 20 hours

Sample weight: 5 g

In Examples or Comparative Examples, resins prepared by the following methods of production were used.

### Production Example 1

### Polymer (A1)-1

A propylene polymer having an intrinsic viscosity of 3.0 dl/g was obtained in accordance with the polymerization methods of propylene homopolymers (HPPs) disclosed in Examples of JP-A-2002-012734 with adjustment of the hydrogen concentration during the polymerization. Subsequently, to 100 parts by weight of this propylene polymer, 0.05 parts by weight of calcium stearate and 0.22 parts by weight of 1,3-bis(tert-butylperoxyisopropyl)benzene as organic peroxide were mixed uniformly, then melt-kneaded at a preset temperature of 250° C. and pelletized by using a twin screw kneading extruder (commercial name: KZW15-45MG, co-rotating type screw 15 mm×45 L/D, manufactured by Technovel Corp.), whereby a polymer ((A1)-1) was obtained. The resulting polymer ((A1)-1) had an intrinsic viscosity of 0.73 dl/g and an Mw/Mn of 2.0.

### Production Example 2

### Polymer ((A1)-2)

Like Production Example 1, in accordance with the polymerization methods of propylene homopolymers (HPPs) disclosed in JP 2002-012737 A with adjustment of the hydrogen concentration during polymerization, a polymer ((A1)-2) having an intrinsic viscosity of 1.0 dl/g and an Mw/Mn of 3.7 was obtained.

### Production Example 3

### Polymer (A1)-3

A propylene polymer having an intrinsic viscosity of 2.8 dl/g was obtained in accordance with the polymerization methods of propylene homopolymers (HPPs) disclosed in Examples of JP 2002-012734A with adjustment of the hydrogen concentration during the polymerization. Subsequently, to 100 parts by weight of this propylene polymer, 0.05 parts by weight of calcium stearate and 0.24 parts by weight of 1,3-bis(tert-butylperoxyisopropyl)benzene as organic peroxide were mixed uniformly, then melt-kneaded at a preset temperature of 250° C. and pelletized by using a twin screw kneading extruder (commercial name: KZW15-45MG, co-rotating type screw 15 mm×45 L/D, manufactured by Technovel Corp.), whereby a polymer ((A1)-3) was obtained. The resulting polymer ((A1)-3) had an intrinsic viscosity of 0.71 dl/g and an Mw/Mn of 1.9.

### Polymer (A1)-4

MF650X (produced by Basell Polyplefins), which had an intrinsic viscosity of 0.51 dl/g and an Mw/Mn of 2.4 was used.

### Production Example 4

### Polymer ((A2)-1)

Like Production Example 1, in accordance with the polymerization methods of propylene homopolymers (HPPs) disclosed in JP 2002-012737 A with adjustment of the hydrogen concentration during polymerization, a polymer ((A2)-1) having an intrinsic viscosity of 2.9 dl/g and an Mw/Mn of 3.6 was obtained.

### Production Example 5

### Polypropylene Resin Component (C)-1

Vacuum was applied to the inside of a 3-liter stainless steel autoclave equipped with a stirrer having been dried under reduced pressure, purged with argon gas, and then cooled. Incidentally, 4.4 mmol of triethylaluminum, 0.44 mmol of cyclohexylethyldimethoxysilane, and 11.1 mg of a solid catalyst component disclosed in Example 1(2) of JP 2002-182981 A were brought into contact with each other in heptane contained in a glass charger and then fed at once. Moreover, 780 g of liquefied propylene was fed, 280 mmHg hydrogen was charged into the autoclave, and then the temperature was raised up to 70° C. to initiate polymerization of propylene. Twenty minutes after the initiation of the polymerization, unreacted propylene was purged out of the autoclave. The autoclave was purged with argon and then a small amount of the polymer was sampled (the first step). The intrinsic viscosity (A) of the sampled homopolypropylene was 2.7 dl/g. After the sampling, the temperature of the autoclave was adjusted to 55° C., then ethylene gas and propylene gas were flowed in the autoclave in flow rates of 2.5 NL/min and 6.0 NL/min, respectively, thereby initiating polymerization to form an ethylene-propylene copolymer. After 60 minutes, the feed of ethylene and propylene gas was stopped and the polymerization was finished (the second step). The yield of polypropylene resin component (C)-1 finally obtained was 289 g and the intrinsic viscosity thereof ([η]C) was 2.9 dl/g. The content of copolymer (B)-1 in (C)-1 calculated from ¹³C-NMR was 53% by weight, the ethylene content in copolymer (B)-1 was 38% by weight, and the intrinsic viscosity ([η]B) was 3.1 dl/g.

### Production Example 6

### Polypropylene Resin Component (C)-2

Operations were carried out in the same manner as Production Example 1 except for changing the amount of the solid catalyst component to 11.3 mg and the amount of hydrogen added in the earlier stage (the first step) to 6840 mmHg. The intrinsic viscosity ([η]A) of the homopolypropylene sampled in the first step was 1.0 dl/g. The yield of the polymer finally obtained was 332 g and polypropylene resin component (C)-2 had an intrinsic viscosity ([η]C) of 1.9 dl/g. The content of copolymer (B)-2 in (C)-2 calculated from ¹³C-NMR was 36% by weight, the ethylene content in copolymer (B)-2 was 38% by weight, and the intrinsic viscosity ([η]B) was 3.4 dl/g.

### Production Example 7

### Polypropylene Resin Component (C)-3

Operations were carried out in the same manner as Production Example 5 except for changing the amount of the solid catalyst component to 11.0 mg. The intrinsic viscosity ([η]A) of the homopolypropylene sampled in the first step was 3.4 dl/g. The yield of the polymer finally obtained was 287 g and polypropylene resin component (C)-3 had an intrinsic viscosity ([η]C) of 3.0 dl/g. The content of copolymer (B)-3 in (C)-3 calculated from ¹³C-NMR was 57% by weight, the ethylene content in copolymer (B)-3 was 29% by weight, and the intrinsic viscosity ([η]B) was 2.8 dl/g.

### Production Example 8

### Polypropylene Resin Component (C)-4

Operations were carried out in the same manner as Production Example 5 except for changing the amount of the solid catalyst component to 12.6 mg. The intrinsic viscosity ([η]A) of the homopolypropylene sampled in the first step was 2.9 dl/g. The yield of the polymer finally obtained was 320 g and polypropylene resin component (C)-4 had an intrinsic viscosity ([η]C) of 2.8 dl/g. The content of copolymer (B)-4 in (C)-4 calculated from ¹³C-NMR was 54% by weight, the ethylene content in copolymer (B)-4 was 28% by weight, and the intrinsic viscosity ([η]B) was 2.8 dl/g.

### Production Example 9

### Polypropylene Resin Component (C)-5

Operations were carried out in the same manner as Production Example 5 except for changing the amount of the solid catalyst component to 12.0 mg and the polymerization time in the later stage (the second step) to 30 minutes. The intrinsic viscosity ([η]A) of the homopolypropylene sampled in the first step was 2.9 dl/g. The yield of the polymer finally obtained was 237 g and polypropylene resin component (C)-5 had an intrinsic viscosity ([η]C) of 2.9 dl/g. The content of copolymer (B)-5 in (C)-5 calculated from ¹³C-NMR was 38% by weight, the ethylene content in copolymer (B)-5 was 30% by weight, and the intrinsic viscosity ([η]B) was 2.8 dl/g.

### Production Example 10

### Polypropylene Resin Component (C)-6

Operations were carried out in the same manner as Production Example 5 except for changing the amount of the solid catalyst component to 14.2 mg and the polymerization time in the later stage (the second step) to 20 minutes. The intrinsic viscosity ([η]A) of the homopolypropylene sampled in the first step was 3.0 dl/g. The yield of the polymer finally obtained was 233 g and polypropylene resin component (C)-6 had an intrinsic viscosity ([η]C) of 2.9 dl/g. The content of copolymer (B)-6 in (C)-6 calculated from ¹³C-NMR was 31% by weight, the ethylene content in copolymer (B)-6 was 31% by weight, and the intrinsic viscosity ([η]B) was 2.7 dl/g.

### Production Example 11

### Polypropylene Resin Component (C)-7

Operations were carried out in the same manner as Production Example 5 except for changing the amount of the solid catalyst component to 13.7 mg and the polymerization time in the later stage (the second step) to 15 minutes. The intrinsic viscosity ([η]A) of the homopolypropylene sampled in the first step was 3.1 dl/g. The yield of the polymer finally obtained was 194 g and polypropylene resin component (C)-7 had an intrinsic viscosity ([C]C) of 2.9 dl/g. The content of copolymer (B)-7 in (C)-7 calculated from ¹³C-NMR was 24% by weight, the ethylene content in copolymer (B)-7 was 33% by weight, and the intrinsic viscosity ([η]B) was 2.3 dl/g.

### Production Example 12

### Polypropylene Resin Component (C)-8

Operations were carried out in the same manner as Production Example 5 except for changing the amount of the solid catalyst component to 16.2 mg, the amount of hydrogen added in the earlier stage (the first step) to 350 mmHg, and the polymerization time of the later stage (the second step) to 11 minutes. The intrinsic viscosity ([η]A) of the homopolypropylene sampled in the first step was 2.6 dl/g. The yield of the polymer finally obtained was 228 g and polypropylene resin component (C)-8 had an intrinsic viscosity ([η]C) of 2.7 dl/g. The content of copolymer (B)-8 in (C)-8 calculated from ¹³C-NMR was 16% by weight, the ethylene content in copolymer (B)-8 was 36% by weight, and the intrinsic viscosity ([η]B) was 3.1 dl/g.

### Production Example 13

### Polypropylene Resin Component (C)-9

Operations were carried out in the same manner as Production Example 5 except for changing the amount of the solid catalyst component to 8.6 mg, the amount of hydrogen added in the earlier stage (the first step) to 4940 mmHg, and the polymerization time of the earlier stage (the first step) to 30 minutes. The intrinsic viscosity ([η]A) of the homopolypropylene sampled in the first step was 1.1 dl/g. The yield of the polymer finally obtained was 294 g and polypropylene resin component (C)-9 had an intrinsic viscosity ([η]C) of 1.5 dl/g. The content of copolymer (B)-9 in (C)-9 calculated from ¹³C-NMR was 30% by weight, the ethylene content in copolymer (B)-9 was 37% by weight, and the intrinsic viscosity ([η]B) was 2.6 dl/g.

### Production Example 14

### Polypropylene Resin Component (C)-10

Operations were carried out in the same manner as Production Example 5 except for changing the amount of the solid catalyst component to 7.6 mg, the amount of hydrogen added in the earlier stage (the first step) to 4940 mmHg, the polymerization time of the earlier stage (the first step) to 30 minutes, and the polymerization temperature of the later stage (the second step) to 57° C. The intrinsic viscosity ([η]A) of the homopolypropylene sampled in the first step was 1.1 dl/g. The yield of the polymer finally obtained was 272 g and polypropylene resin component (C)-10 had an intrinsic viscosity ([η]C) of 1.7 dl/g. The content of copolymer (B)-10 in (C)-10 calculated from ¹³C-NMR was 28% by weight, the ethylene content in copolymer (B)-10 was 39% by weight, and the intrinsic viscosity ([η]B) was 3.5 dl/g.

### Example 1

A resin composition was prepared by mixing 60% by weight of polymer (A1)-1, 5% by weight for polymer (A2)-1, 35% by weight of polypropylene resin component (C)-1, and stabilizers (SUMILIZER GA80 and SUMILIZER GP, both produced by Sumitomo Chemical Co., Ltd.) uniformly, and then melt-kneading them by using a twin screw kneading extruder (commercial name: KZW15-45MG, co-rotating type screw 15 mm×45 L/D, manufactured by Technovel Corp.) under conditions represented by a preset temperature of 200° C. and a screw rotation speed of 500 rpm. Physical properties of the resulting resin composition are shown in Tables 1 and 2.

### Comparative Example 1

A resin composition was obtained in the same manner as Example 1 except for using 44% by weight of propylene polymer (A1)-2 and 56% by weight of polypropylene resin component (C)-2. Physical properties of the resulting resin composition are shown in Tables 1 and 2.

### Comparative Example 2

A resin composition was obtained in the same manner as Example 1 except for using changing the load of polymer (A1)-1 to 48% by weight and the load of polymer (A2)-1 to 17% by weight. Physical properties of the resulting resin composition are shown in Tables 1 and 2.

### Example 2

A resin composition was obtained in the same manner as Example 1 except for using 80% by weight of propylene polymer (A1)-3 and 20% by weight of polypropylene resin component (C)-3. Physical properties of the resulting resin composition are shown in Tables 1 and 2.

### Example 3

A resin composition was obtained in the same manner as Example 1 except for using 60% by weight of propylene polymer (A1)-3 and 40% by weight of polypropylene resin component (C)-4. Physical properties of the resulting resin composition are shown in Tables 1 and 2.

### Comparative Example 3

A resin composition was obtained in the same manner as Example 1 except for using 50% by weight of propylene polymer (A1)-4 and 50% by weight of polypropylene resin component (C)-3. Physical properties of the resulting resin composition are shown in Tables 1 and 2.

### Example 4

A resin composition was obtained in the same manner as Example 1 except for using 68% by weight of propylene polymer (A1)-3 and 32% by weight of polypropylene resin component (C)-6. Physical properties of the resulting resin composition are shown in Tables 1 and 2.

### Example 5

A resin composition was obtained in the same manner as Example 1 except for using 58% by weight of propylene polymer (A1)-4 and 42% by weight of polypropylene resin component (C)-7. Physical properties of the resulting resin composition are shown in Tables 1 and 2.

### Example 6

A resin composition was obtained in the same manner as Example 1 except for using 74% by weight of propylene polymer (A1)-3 and 26% by weight of polypropylene resin component (C)-5. Physical properties of the resulting resin composition are shown in Tables 1 and 2.

### Comparative Example 4

A resin composition was obtained in the same manner as Example 1 except for using 42% by weight of propylene polymer (A1)-4 and 58% by weight of polypropylene resin component (C)-8. Physical properties of the resulting resin composition are shown in Tables 1 and 2.

### Comparative Example 5

A resin composition was obtained in the same manner as Example 1 except for using 68% by weight of propylene polymer (A1)-3 and 32% by weight of polypropylene resin component (C)-9. Physical properties of the resulting resin composition are shown in Tables 1 and 2.

### Comparative Example 6

A resin composition was obtained in the same manner as Example 1 except for using 64% by weight of propylene polymer (A1)-3 and 36% by weight of polypropylene resin component (C)-10. Physical properties of the resulting resin composition are shown in Tables 1 and 2.

It is shown that Example 1, which satisfies the requirements of the present invention, is superior in balance between flowability and tensile elongation at break and little in extraction to n-hexane.

Conversely, it is shown that Comparative Example 1, which fails to satisfy the Mw/Mn of polymer (A1) required by the present invention and fails to contain polymer (A2), exhibits a small tensile elongation at break and also that Comparative Example 2, which fails to satisfy the MFR required by the present invention, is high in shear viscosity and therefore insufficient in flowability.

TABLE 1
Resin Composition

| | Polymer | | | | | | | Copolymer | | Mw < |
|---|---|---|---|---|---|---|---|---|---|---|
| | (A1) | | | Proportion | (A2) | | | (B) | | 21000 |
| | Content | | | of regio | Content | | | Content | MFR | Content |
| | % by | [η] | | defects | % by | [η] | | % by | g/10 | % by |
| | weight | d1/g | Mw/Mn | % | weight | d1/g | Mw/Mn | weight | min | weight |
| Example 1 | 60 | 0.73 | 2.0 | <0.01 | 20 | 2.7 | 3.8 | 20 | 31 | 3.0 |
| Comparative | 80 | 1.02 | 3.7 | <0.01 | — | | | 20 | 26 | 5.5 |
| Example 1 | | | | | | | | | | |
| Comparative | 48 | 0.73 | 2.0 | <0.01 | 32 | 2.7 | 3.8 | 20 | 13 | 2.6 |
| Example 2 | | | | | | | | | | |
| Example 2 | 80 | 0.71 | 1.9 | <0.01 | 9 | 3.4 | 3.1 | 11 | 87 | 3.4 |
| Example 3 | 60 | 0.71 | 1.9 | <0.01 | 18 | 2.9 | 3.1 | 22 | 27 | 3.2 |
| Comparative | 50 | 0.51 | 2.4 | 0.35 | 22 | 3.4 | 3.1 | 28 | 14 | 5.5 |
| Example 3 | | | | | | | | | | |
| Example 4 | 68 | 0.71 | 1.9 | <0.01 | 22 | 3.0 | 3.1 | 10 | 38 | 3.0 |
| Example 5 | 58 | 0.51 | 2.4 | 0.35 | 32 | 3.1 | 3.8 | 10 | 22 | 5.2 |
| Example 6 | 74 | 0.71 | 1.9 | <0.01 | 16 | 2.9 | 3.4 | 10 | 59 | 2.9 |
| Comparative | 42 | 0.51 | 2.4 | 0.35 | 49 | 2.6 | 3.5 | 9 | 7 | 5.2 |
| Example 4 | | | | | | | | | | |
| Comparative | 68 | 0.71 | 1.9 | <0.01 | 22 | 1.1 | 6.3 | 10 | 127 | 4.0 |
| Example 5 | | | | | | | | | | |
| Comparative | 64 | 0.71 | 1.9 | <0.01 | 26 | 1.1 | 5.9 | 10 | 107 | 4.0 |
| Example 6 | | | | | | | | | | |

TABLE 2

| | Tensile | | Amount of | Amount of | | Fogging |
|---|---|---|---|---|---|---|
| | elongation | Shear | extraction | volatile | Amount of | Gloss |
| | at break | viscosity | in n-hexane | substance | oligomer | retention |
| | % | poise | % by weight | ppm | ppm | % |
| Example 1 | 1430 | 425 | 3.7 | 75 | 1500 | 94.0 |
| Comparative | 170 | 397 | 4.4 | 880 | 2900 | 91.0 |
| Example 1 | | | | | | |
| Comparative | 1390 | 538 | 3.5 | 54 | 1400 | 94.2 |
| Example 2 | | | | | | |
| Example 2 | 1667 | 303 | 1.7 | 330 | 1800 | 58.5 |
| Example 3 | 1638 | 452 | 2.8 | 280 | 1300 | 70.4 |
| Comparative | 1373 | 440 | 4.1 | 40 | 380 | 68.8 |
| Example 3 | | | | | | |
| Example 4 | 1818 | 389 | 1.5 | 260 | 1600 | 63.8 |
| Example 5 | 1551 | 362 | 1.6 | 56 | 390 | 93.7 |
| Example 6 | 1787 | 352 | 1.6 | 280 | 1800 | 59.2 |
| Comparative | 1250 | 470 | 1.4 | 880 | 320 | 93.6 |
| Example 4 | | | | | | |
| Comparative | 944 | 267 | 2.2 | 230 | 2200 | 64.9 |
| Example 5 | | | | | | |
| Comparative | 789 | 290 | 2.1 | 230 | 2200 | 75.0 |
| Example 6 | | | | | | |

1. A resin composition comprising 20 to 80% by weight of polymer (A1) defined below, 5 to 55% by weight of polymer (A2) defined below, and 10 to 50% by weight of copolymer (B) defined below, where the total weight of the polymer (A1), the polymer (A2), and the copolymer (B) is considered to be 100% by weight, wherein the melt flow rate (MFR) of the resin composition measured at 230° C. under a load of 2.16 kg is 20 g/10 min or more,
polymer (A1): a propylene polymer having an intrinsic viscosity measured in 135° C. Tetralin ([η]^{A1}_{P}) of not lower than 0.5 dl/g but lower than 2.0 dl/g, a molecular weight distribution (Mw/Mn) of less than 3.0, and a content of structural units derived from propylene of 90% by weight or more,
polymer (A2): a propylene polymer having an intrinsic viscosity measured in 135° C. Tetralin ([η]^{A2}_{P}) of not lower than 2.0 dl/g and not higher than 7.0 dl/g, a molecular weight distribution (Mw/Mn) of not less than 3.0, and a content of structural units derived from propylene of 90% by weight or more,
copolymer (B): a copolymer of ethylene with propylene or an α-olefin having 4 to 20 carbon atoms having a content of structural units derived from ethylene of 20 to 80% by weight.

2. The resin composition according to claim 1, wherein the resin composition contains components having a weight average molecular weight (Mw) of not more than 21000 in a total content of less than 5.0% by weight.

3. The resin composition according to claim 1, wherein the polymer (A1) has a proportion of regio defects caused by 2,1-insertion and 1,3-insertion in all propylene units measured by ¹³C-NMR spectroscopy of 0.01% or less.

4. The resin composition according to claim 1, wherein the resin composition is produced by producing a polypropylene resin component (C) composed of the polymer (A2) and the copolymer (B) by multistage polymerization, and then mixing the polypropylene resin component (C) with the polymer (A1).

5. A method for producing the resin composition according to claim 1, the method comprising a step of producing a polypropylene resin component (C) composed of polymer (A2) and copolymer (B) by multistage polymerization, and a step of producing a resin composition by mixing the polypropylene resin component (C) with polymer (A1).

6. A molded article of the resin composition according to claim 1.
